(19) United States
(12) Patent Application Publication
(10) Pub. No.: US 2006/0262941 A1
(43) Pub. Date: Nov. 23, 2006

(54) Speaker array system

(75) Inventor: Rento Tanase, Iwata-shi (JP)

Correspondence Address: HARNESS, DICKEY & PIERCE, P.L.C., P.O. BOX 828, BLOOMFIELD HILLS, MI, 48303, US

(73) Assignee: Yamaha Corporation, Hamamatsu-shi (JP)

(21) Appl. No.: 11/410,328

(22) Filed: Apr. 24, 2006

(30) Foreign Application Priority Data
Apr. 25, 2005 (JP) 2005-126320

(51) Int. Cl. H04R 29/00

(52) U.S. Cl. 381/59

(57) ABSTRACT

A speaker array system which can be set up with ease and make it possible to minimize the distances between amplifiers and speakers and improve sound quality. A plurality of speakers (70-1 to 70-n) are mounted in a single speaker cabinet, and a plurality of amplifier devices (60-1 to 60-n) drive the plurality of speakers. A signal processing device (30) carries out signal processing on an input musical tone signal so as to generate acoustic beams from outputs of the plurality of speakers. A wireless transmitting device (40) and a wireless receiving device (50) are disposed on a signal line in a preceding or subsequent stage of the signal processing device, for transmitting and receiving signals by radio.

### BACKGROUND OF THE INVENTION

1. Field of the Invention

The present invention relates to a speaker array system using wireless communication.

2. Description of the Related Art

A speaker system in which a large number of speaker units are arranged is referred to as a “speaker array.” In the speaker array, speaker's directivities can be sharp and the directions of acoustic beams can be controlled by controlling delays and gains which are to be given to musical tone signals which are to be supplied to the respective speakers. If speaker's directivities are sharp, the same energy is radiated in a narrower range, and hence the distance attenuation of sound pressure is decreased, so that sound can be clearly heard even at locations far away from a sound source. Also, acoustic radiation in unnecessary directions can be suppressed. Further, if the directions of acoustic beams can be controlled, limitations on the manner in which the speakers are placed can be reduced since the speakers should not necessarily be pointed to sound hearing positions. A speaker array of this type has been disclosed in, for example, Japanese Laid-Open Patent Publication (Kokai) No. H09-233591.

In general, to supply musical tone signals to respective speakers, signal lines must be laid between amplifiers and the speakers. When the signal lines from the amplifiers to the speakers are long, there is the problem that sound quality is degraded due to signal attenuation or noise generation.

### SUMMARY OF THE INVENTION

It is an object of the present invention to provide a speaker array system which can be set up with ease and make it possible to minimize the distances between amplifiers and speakers and inhibit degradation of sound quality.

To attain the above object, in a first aspect of the present invention, there is provided a speaker array system comprising a plurality of speakers mounted in a single speaker cabinet, a plurality of amplifier devices that drive the plurality of speakers, a signal processing device that carries out signal processing on an input musical tone signal so as to generate acoustic beams from outputs of the plurality of speakers, and a wireless transmitting device and a wireless receiving device disposed on a signal path in a preceding stage or subsequent stage of the signal processing device, for transmitting and receiving signals by radio.

With the arrangement of first aspect of the present invention, since the amplifier devices and the speakers correspond to each other on a one-on-one basis, the distances between the amplifier devices and the speakers can be minimized. As a result, sound quality can be improved. Further, with the arrangement of this speaker array system, using the wireless transmitting device and the wireless receiving device eliminates the need to lay signal lines, wiring at the time of setup can be simplified, and the amount of work required for setup can be reduced. Also, since there is no need to lay signal lines, the problem that the probability of occurrence of connection errors is increased can be solved. Further, the cost of signal lines can be reduced, and the total weight of the speaker array system can be decreased. In addition, since signal lines that cause so-called “fluttering sounds” are reduced, degradation of the quality of musical tones reproduced by the speaker array system can be inhibited.

Preferably, the signal processing device generates a plurality of output musical tone signals for respective ones of the plurality of speakers from the input musical tone signal, the wireless transmitting device transmits by radio the plurality of output musical tone signals generated by the signal processing device, the wireless receiving device comprises a plurality of wireless receivers provided in association with respective ones of the plurality of amplifier devices, for receiving associated ones of the plurality of output musical tone signals transmitted by radio and outputting the received output musical tone signals to respective associated ones of the plurality of amplifier devices, and the plurality of amplifier devices, the signal processing device, the wireless transmitting device, and the plurality of wireless receivers are provided within the speaker cabinet.

With this arrangement, since the signal processing device is disposed in a preceding stage of the wireless transmitting device, the arrangement of the receiving end that receives output musical tone signals can be simplified.

Preferably, the wireless transmitting device transmits the input musical tone signal by radio, the wireless receiving device comprises a plurality of wireless receivers provided in association with respective ones of the plurality of amplifier devices, for receiving the input musical tone signal transmitted by radio, the signal processing device comprises a plurality of signal processors provided in association with respective ones of the plurality of wireless receivers, for generating a plurality of output musical tone signals for respective ones of the plurality of speakers from the input musical tone signal received by the wireless receivers and outputting the generated output musical tone signals to respective associated ones of the plurality of amplifier devices, and the plurality of amplifier devices, the plurality of signal processors, the wireless transmitting device, and the plurality of wireless receivers are provided within the speaker cabinet.

With this arrangement, since the wireless transmitting device may transmit the same signal to all the wireless receiving devices, the arrangement of the wireless transmitting device can be simplified.

Preferably, the wireless transmitting device transmits the input musical tone signal by radio, the wireless receiving device receives the input musical tone signal transmitted by radio, the signal processing device generates a plurality of output musical tone signals for respective ones of the plurality of speakers from the input musical tone signal received by the wireless receiving device and outputs the generated output musical tone signals to respective associated ones of the plurality of amplifier devices via a network, and the plurality of amplifier devices, the signal processing device, the wireless transmitting device, and the wireless receiving device are provided within the speaker cabinet.

With this arrangement, since only one wireless receiving device needs to be provided for all the speakers, the arrangement of the speaker array system can be simplified.

Preferably, the wireless transmitting device transmits the input musical tone signal by radio, the wireless receiving device receives the input musical tone signal transmitted by radio, the signal processing device comprises a plurality of signal processors provided in association with respective ones of the plurality of amplifier devices and connected to the wireless receiving device via a network, for generating a plurality of output musical tone signals for respective ones of the plurality of speakers from the input musical tone signal received by the wireless receiving device and outputting the generated output musical tone signals to respective associated ones of the plurality of amplifier devices, and the plurality of amplifier devices, the plurality of signal processors, the wireless transmitting device, and the wireless receiving device are provided within the speaker cabinet.

With this arrangement, since only one wireless receiving device needs to be provided for all the speakers, the arrangement of the speaker array system can be simplified.

Preferably, the speaker cabinet is formed of a material that shields electromagnetic waves.

Preferably, each of the plurality of speakers comprises a case formed of a material that shields electromagnetic waves.

With this arrangement, since the speaker cabinet or the speakers themselves are made of a material that shields electromagnetic waves, electromagnetic waves from outside can be shielded, and electromagnetic waves can be prevented from being leaked to outside.

Preferably, each of said plurality of speakers and each of said plurality of amplifier devices are housed in a speaker unit, and the speaker unit is comprised of a cylindrical exterior member on which screw threads for fitting the speaker unit into the speaker cabinet are formed and that is made of a conductive material, terminals that are made of a conductive material, and an insulating layer that is formed between the cylindrical exterior member and the terminals.

The above and other objects, features, and advantages of the invention will become more apparent from the following detained description taken in conjunction with the accompanying drawings.

### BRIEF DESCRIPTION OF THE DRAWINGS

FIG. 1 is a block diagram showing the arrangement of a speaker array system according to a first embodiment of the present invention;

FIG. 2 is a view showing an example in which the speaker array system is set up;

FIG. 3A is a view showing the appearance of a speaker unit;

FIG. 3B is a cross sectional view showing the speaker unit;

FIG. 4 is a block diagram showing the arrangement of a speaker array system according to a second embodiment of the present invention;

FIG. 5 is a block diagram showing the arrangement of a speaker array system according to a third embodiment of the present invention; and

FIG. 6 is a block diagram showing the arrangement of a speaker array system according to a fourth embodiment of the present invention.

### DETAILED DESCRIPTION OF THE PREFERRED EMBODIMENTS

The present invention will now be described in detail with reference to the drawings showing preferred embodiments thereof. In the drawings, elements and parts which are identical throughout the views are designated by identical reference numeral, and duplicate description thereof is omitted.

### First Embodiment

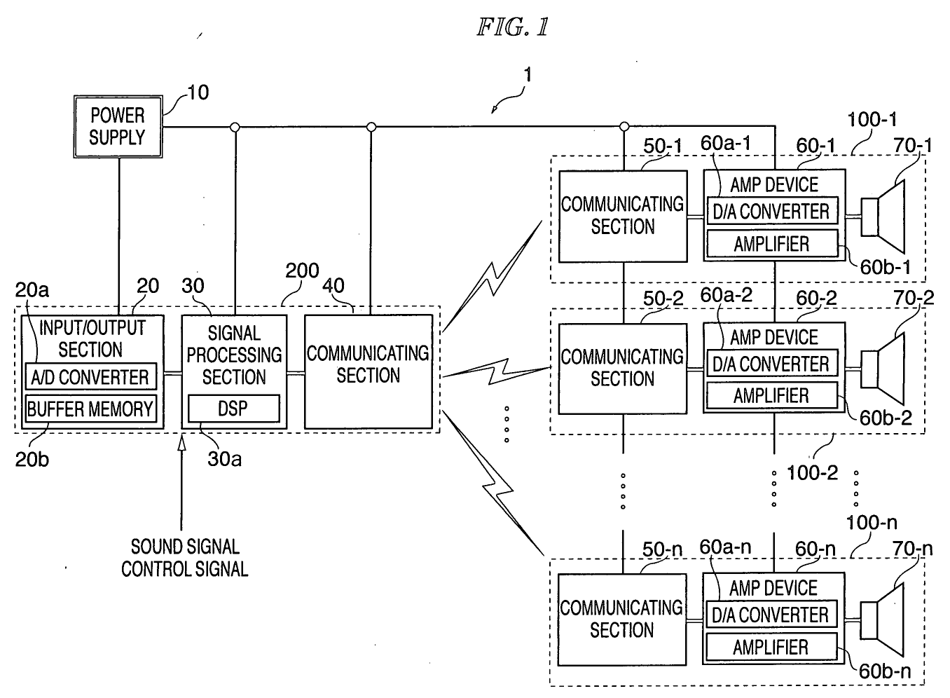

FIG. 1 is a block diagram showing the arrangement of a speaker array system according to a first embodiment of the present invention. The speaker array system 1 is comprised of n speakers 70. In the following description, when it is necessary to discriminate between each of the speakers 70 and the other ones, subscripts are added to the reference numeral “70”; e.g. “the speaker 70-1” and “the speaker 70-2.” When it is unnecessary to discriminate between each of the speakers 70 and the other ones, the speaker 70 is designated merely as “the speaker 70.” This also applies to component elements other than the speakers 70.

In the speaker array system 1, a musical tone signal and a control signal from an external device, not shown, are input to an input/output section 20. In the following description, the term “musical tone signal” refers to a signal indicative of sound encompassing a wide range of sound such as voice and music, and the term “control signal” refers to a signal containing information indicative of positions at which acoustic beams generated by a speaker array are converged. The input/output section 20 is comprised of an A/D converter 20a, a buffer memory 20b, and so forth, which are not illustrated. The input/output section 20 outputs the input musical tone signal and control signal to a signal processing section 30. The signal processing section 30 is comprised of a DSP (Digital Signal Processor) 30a and others, which are not illustrated. The signal processing section 30 carries out necessary processing on the musical tone signal so that acoustic beams can be converged at the positions indicated by the control signal. The signal processing section 30 outputs the processed musical tone signal to a communicating section 40. The communicating section 40 transmits the musical tone signal to a communicating section 50 by radio. In the present embodiment, the input/output section 20, the signal processing section 30, and the communicating section 40 constitute a wireless LAN station 200.

An amplifier (AMP) device 60 that supplies musical tone signals is connected to each of the speakers 70. The AMP devices 60 are each comprised of a D/A converter 60a, an amplifier 60b, and so forth. The speakers 70 and the AMP devices 60 correspond to each other on a one-on-one basis. Further, a communicating section 50 for receiving musical tone signals using wireless communication is connected to each of the AMP devices 60. The communicating sections 50 and the AMP devices 60 correspond to each other on a one-on-one basis. That is, dedicated AMP device 60 and communicating section 50 are connected to a given speaker 70. In the present embodiment, the speaker 70, the AMP device 60, and the communicating sections 50 constitute a speaker unit 100. The speaker 70 outputs a musical tone based on the musical tone signal received by the communicating section 50.

A power supply 10 supplies power to the input/output section 20, the signal processing section 30, the communicating section 40, the communicating sections 50, and the AMP devices 60. It should be noted that thin lines in FIG. 1 indicate power lines PL.

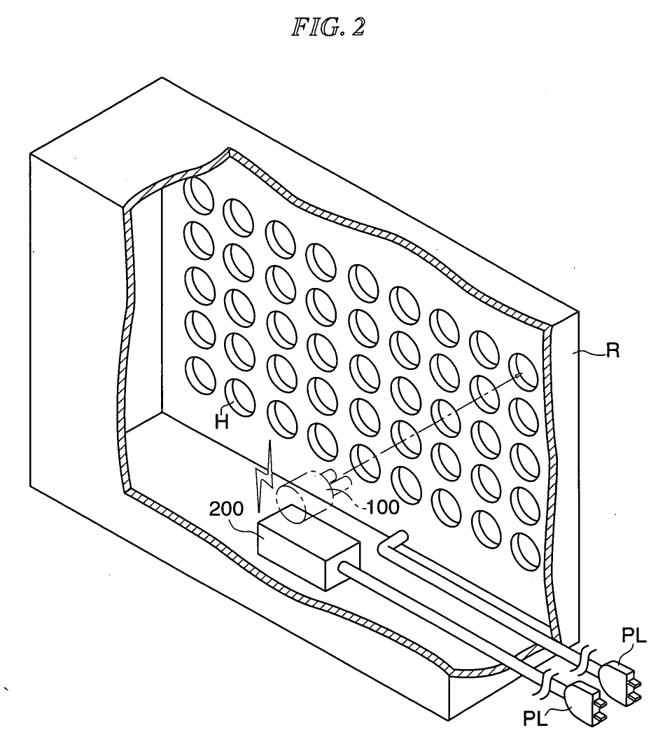

FIG. 2 is a view showing an example of how the speaker array system 1 is set up. The speaker 70, the AMP device 60, and the communicating section 50 are attached on a single case and constitute the speaker unit 100. That is, the speaker array system 1 has n speaker units 100. Also, the input/output section 20, the signal processing section 30, and the communicating section 40 are formed in a single case and constitute the wireless LAN station 200.

In the example illustrated in FIG. 2, the n speaker units 100 are fitted into holes H formed in a wall of a room R. The wireless LAN station 200 is placed on a floor of the room R. The wireless LAN station 200 is connected via a signal line to a device, not shown, which outputs musical tones signals and control signals. The wireless LAN station 200 is also connected to the power supply 10 via a power line PL, thereby operating using the power supplied from the power supply 10. Although described later in detail, the wall of the room R is configured to supply the power from the power supply 10 to the speaker units 100, and the wall and the power supply 10 are connected to each other via a power line PL.

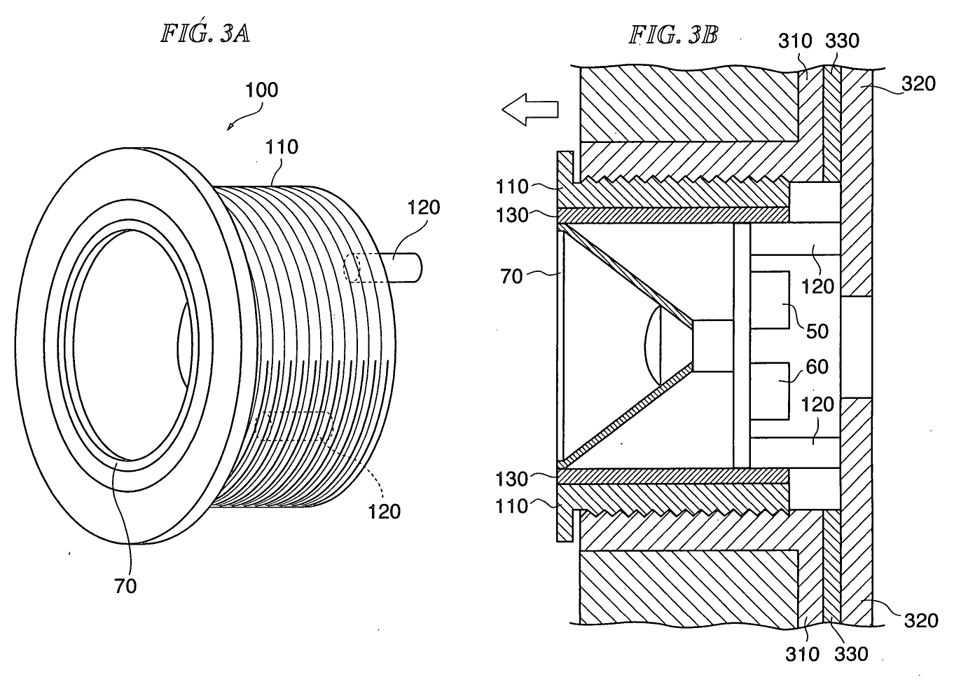

FIG. 3A is a view showing the appearance of the speaker unit 100, and FIG. 3B is a cross sectional view showing the speaker unit 100 and the wall of the room R. The speaker unit 100 is constructed such that the speaker 70, the AMP device 60, and the communicating section 50 are housed in a cylindrical exterior member 110. Screw threads for fitting the speaker unit 100 into the wall are cut in the exterior member 110. Also, the exterior member 110 is made of a conductive material such as metal so as to function as a contact with the power line PL. Also, terminals 120 for obtaining contacts of the opposite polarity from the power supply 10 are formed on an inner surface of the exterior member 110, and are made of a conductive material. An insulating layer 130 is formed between the terminals 120 and the exterior member 110, so that the exterior member 110 and the terminals 120 are insulated from each other.

An electrode 310 and an electrode 320 for supplying power to the speaker unit 100 are formed in an inner surface of the hole H. The electrode 310 is formed along the inner surface of the hole H and is cylindrical in form. The arrow in FIG. 3B indicates the inner side of the room R (the side on which a listener lies and the outer side as viewed from the speaker array system 1 and the wall). The electrode 310, the electrode 320, and an insulating plate 330 for insulating the electrodes 310 and 320 from each other are formed on the inner side of the wall. Screw threads for fitting the speaker unit 100 into the electrode 310 are cut in an inner surface of the electrode 310. By fitting the speaker unit 100 into the hole H, the speaker unit 100 can be fixed to the wall of the room R. With the speaker unit 100 fitted in the hole H, the terminals 120 are brought into contact with the electrode 320. The electrode 310 and the electrode 320 are connected to the power line PL at certain locations, not shown, of the wall to supply the power from the power supply 10 to the speaker unit 100. In this way, the power is supplied from the wall of the room R to the speaker unit 100. As described above, the electrode 310 has the function of fixing the speaker unit 100 to the wall and the function of providing a contact between the speaker unit 100 and the power line. It should be noted that a member having the function of fixing the speaker unit 100 to the wall and a member having the function of providing a contact between the speaker unit 100 and the power line may be separately provided.

It should be noted that the method to fit the speaker unit 100 into the hole H is not limited to the method using screw threads. Any method may be employed insofar as the speaker unit 100 can be fixed to the wall. For example, the speaker unit 100 may be screwed into or fitted into the wall. Also, the shapes of the electrode 310 and the electrode 320 are not limited to those mentioned above. The electrode 310 and the electrode 320 may be in any shape insofar as power can be supplied to the speaker unit 100.

The operation of the speaker array system 1 will now be described in further detail with reference to FIGS. 1 and 2. When a musical tone signal and a control signal are input to the input/output section 20 of the wireless LAN station 200, the musical tone signal and the control signal are converted into digital signals by the A/D converter 20a. The musical tone signal and control signal thus converted into digital signals are output to the signal processing section 30. Upon receiving the musical tone signal and the control signal, the signal processing section 30 carries out processing (e.g. gain adjustment, delay processing, and equalizing processing) required for generating acoustic beams designated by the control signal. The signal processing section 30 stores a table or a function in advance in which the positions indicated by the control signal, identifiers that identify the respective speaker units 100 and the processing amounts of signal processing (e.g. delay amounts in the case of delay processing) are associated with each another. The signal processing section 30 calculates processing amounts by referring to the table or function. The signal processing section 30 carries out delay processing on the musical tone signal in accordance with the calculated delay amounts. This also applies to other kinds of processing such as gain adjustment and equalizing processing. In the following description, a musical tone signal on which signal processing has been carried out by the signal processing section 30 will be referred to as an “output musical tone signal.” The signal processing section 30 generates output musical tone signals for the respective n speaker units 100. The signal processing section 30 adds unit identifiers that identify the respective speaker units 100 as destinations of the generated output musical tone signals to the output musical tone signals and outputs the resultant output musical tone signals to the communicating section 40. In the present embodiment, different signals are transmitted to the respective n speaker units 100.

The communicating section 40 transmits the input output musical tone signals by radio to the speaker units 100 identified by the unit identifiers. In the present embodiment, the communicating section 40 and the communicating sections 50 carry out wireless communication using the so-called wireless LAN technology. The communicating section 40 and the communicating sections 50 are each comprised of an antenna, a processor, a memory, and so forth, not shown, required for constructing a wireless LAN. Each of the communicating sections 50 stores an IP address that identifies itself (i.e. the speaker unit 100) in the memory. Examples of the wireless LAN standard include IEEE802.11x. Examples of the unit identifies include an IP address. The communicating section 40 can transmit a wireless signal to a particular communicating section 50 by designating an associated unit identifier.

Upon receiving the output musical signal from the communicating section 40, the communicating section 50 of the speaker unit 100 outputs the received output musical signal to the AMP device 60. In the AMP device 60, the D/A converter 60a carries out digital-to-analog conversion of the output musical tone signal. The output musical tone signal thus converted into analog form is amplified by the amplifier 60b and then output to the speaker 70. The speaker 70 outputs a musical tone based on the input musical tone signal.

As described above, the wireless LAN station 200 transmits different output musical tone signals by radio to the respective n speaker units 100. That is, in a case where a musical tone signal is an m-channel signal, the wireless LAN station 200 transmits m×n musical tone signals by radio. The speaker units 100 receive the respective associated output musical tone signals and output musical tones with different parameters such as delay amounts. In this way, acoustic beams are selectively generated toward the positions designated by a control signal.

With the arrangement of the speaker array system 1 according to the present embodiment, since the AMP devices 60 and the speakers 70 correspond to each other on a one-on-one basis, the distance between the AMP device 60 and the speaker 70 can be minimized by configuring the AMP device 60 and the speaker 70 as an integral unit. As a result, sound quality can be improved. Further, with the arrangement of the speaker array system 1 according to the present embodiment, since there is no need to lay signal lines between the wireless LAN station 200 and the speaker units 100, wiring at the time of setup can be simplified, and the amount of work required for setup can be reduced. Also, since there is no need to lay signal lines, the problem that the probability of occurrence of connection errors is increased can be solved. Further, the cost of signal lines can be reduced, and the total weight of the speaker array system 1 can be decreased. In addition, since signal lines that cause so-called “fluttering sounds” are reduced, degradation of the quality of musical tones reproduced by the speaker array system 1 can be inhibited. Also, a digital signal such as the musical signal can be transmit from the input/output section 20 to the AMP device 60 so that degradation of tone quality can be inhibited.

### Second Embodiment

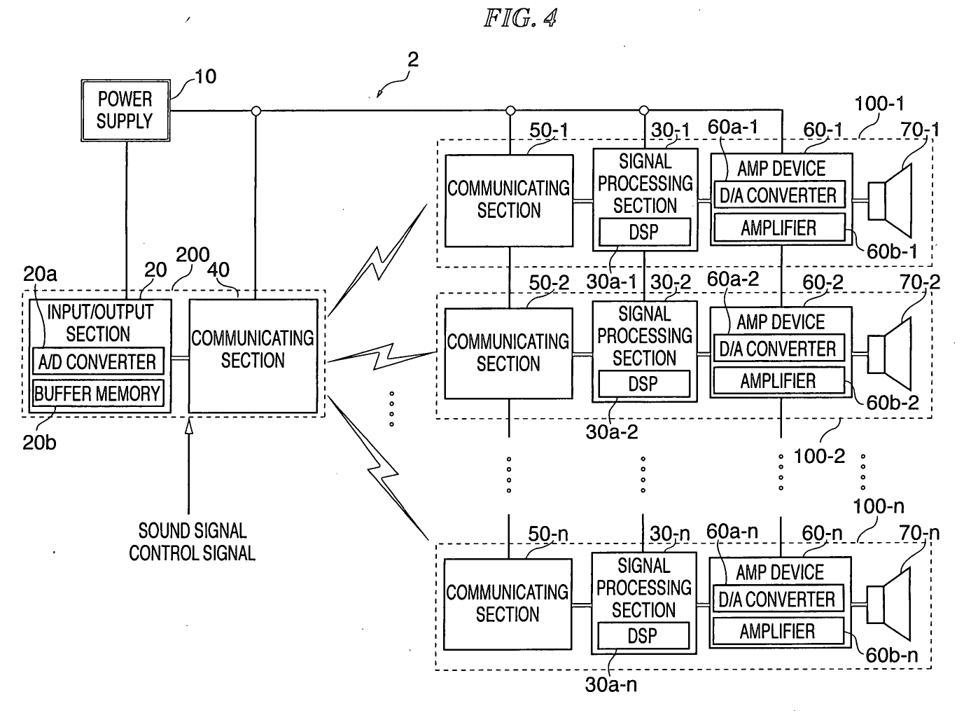

FIG. 4 is a block diagram showing the arrangement of a speaker array system 2 according to a second embodiment of the present invention. In FIG. 4, component elements corresponding to those of the speaker array system 1 according to the first embodiment are designated by identical reference numerals. Also, in the following description, differences from the first embodiment are focused, and description of matters in common with those of the first embodiment is omitted.

The speaker array system 2 differs from the speaker array system 1 according to the first embodiment in that the signal processing section 30 is located in a subsequent stage of each communicating section 50. Specifically, in the speaker array system 1, the signal processing section 30 is located inside the wireless LAN station 200, whereas in the speaker array system 2, the signal processing section 30 is located inside each of the speaker units 100. As shown in FIG. 4, in the present embodiment, the speaker unit 100 is comprised of the communicating section 50, the signal processing section 30, the AMP device 60, and the speaker 70.

In the speaker array system 2, when a musical tone signal and a control signal are input to the input/output section 20 of the wireless LAN station 200, the musical tone signal and the control signal are converted into digital signals by the A/D converter 20a. The musical tone signal and control signal thus converted into digital form are output to the communicating section 40. Upon receiving the musical tone signal and the control signal, the communicating section 40 transmits the musical tone signal and the control signal to the n speaker units 100 by radio. In the present embodiment, the communicating section 40 (the wireless LAN station 200) transmits the same musical tone signal (and control signal) to all the n speaker units 100.

The communicating section 50 of each speaker unit 100 stores in advance a unit identifier that identifies itself, i.e. the speaker unit 100. Upon receiving the musical tone signal and the control signal, the communicating section 50 adds the unit identifier to the received musical tone signal and the control signal and outputs the resultant musical tone signal and control signal to the signal processing section 30.

Upon receiving the musical tone signal and the control signal, the signal processing section 30 carries out processing on the musical tone signal, which is required for generating acoustic beams, in accordance with the control signal. The signal processing section 30 stores in advance a table or a function for outputting the processing amounts of signal processing (e.g. delay amounts in the case of delay processing) with reference to the unit identifier and the positions indicated by the control signal. The signal processing section 30 calculates the processing amount by referring to the table or function. The signal processing section 30 carries out processing on the musical tone signal in accordance with the calculated processing amount. In the present embodiment, the signal processing section 30 generates an output musical tone signal for outputting a musical tone via the corresponding speaker 70. That is, the signal processing sections 30-1, 30-2, . . . , 30-n generate respective different output musical tone signals. The signal processing section 30 outputs the generated output musical tone signal to the AMP device 60.

In the AMP device 60, the D/A converter 60a carries out digital-to-analog conversion of the output musical tone signal. The output musical tone signal thus converted into analog form is amplified by an amplifier 60b and output to the speaker 70. The speaker 70 outputs a musical tone based on the input musical tone signal. In this way, acoustic beams are selectively generated toward the positions designated by the control signal.

With the arrangement of the speaker array system 2 according to the present embodiment, since the AMP devices 60 and the speakers 70 correspond to each other on a one-on-one basis, the distance between the AMP device 60 and the speaker 70 can be minimized by configuring the AMP device 60 and the speaker 70 as an integral unit. As a result, sound quality can be improved. Further, with the arrangement of the speaker array system 2, since there is no need to lay signal lines between the wireless LAN station 200 and the speaker units 100, wiring at the time of setup can be simplified, and the amount of work required for setup can be reduced. Also, since there is no need to lay signal lines, the problem that the probability of occurrence of connection errors is increased can be solved. Further, the cost of signal lines can be reduced, and the total weight of the speaker array system 1 can be decreased. In addition, since signal lines that cause so-called “fluttering sounds” are reduced, degradation of the quality of musical tones reproduced by the speaker array system 1 can be inhibited. Further, with the arrangement of the speaker array system 2, since the wireless LAN station 200 may transmit the same signal to all the speaker units 100, the arrangement of the wireless transmitting means can be simplified.

### Third Embodiment

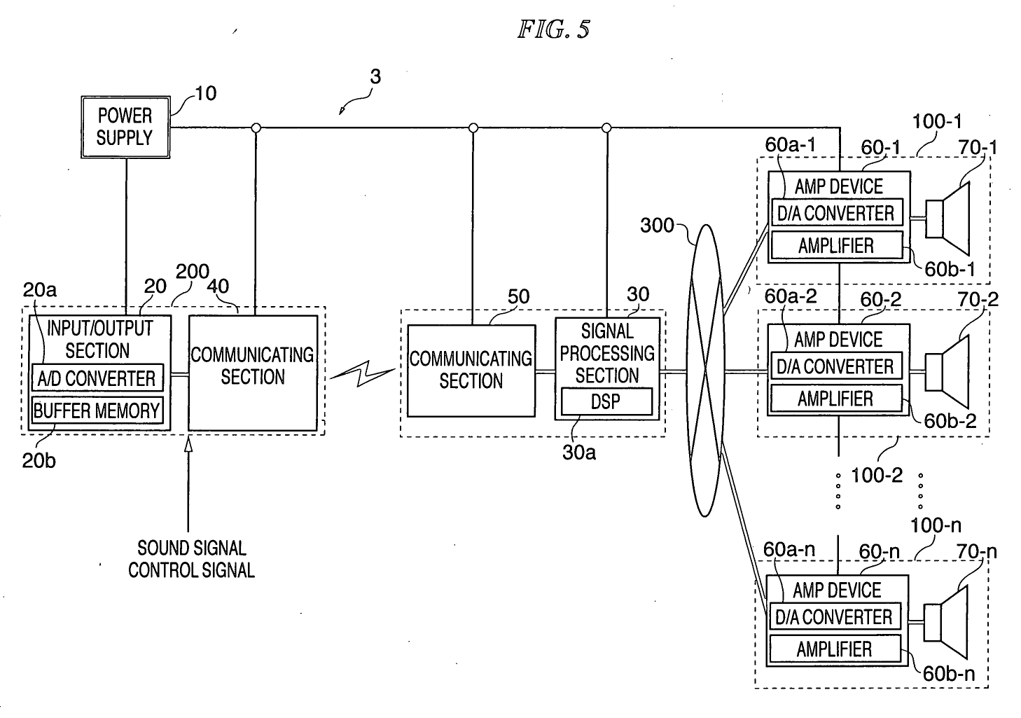

FIG. 5 is a block diagram showing the arrangement of a speaker array system 3 according to a third embodiment of the present invention. In FIG. 5, component elements corresponding to those of the speaker array systems 1 and 2 according to the first and second embodiments are designated by identical reference numerals. Also, in the following description, differences from the first and second embodiments are focused, and description of matters in common with those of the first and second embodiments is omitted.

The speaker array system 3 differs from the speaker array system 2 according to the second embodiment in that each of the speaker units 100 does not have the communicating section 50 and the signal processing section 30, but one communicating section 50 and one signal processing section 30 are shared by all the speaker units 100. Specifically, in the speaker array system 2, each of the speaker units 100 has the speaker 70, the AMP device 60, the signal processing section 30, and the communicating section 50, whereas in the speaker array system 3, each of the speaker units 100 has the speaker 70 and the AMP device 60 as shown in FIG. 5. One communicating section 50 and one signal processing section 30 are shared by the n speaker units 100. The communicating section 50 and the signal processing section 30 constitute a wireless LAN station 400. The wireless LAN station 400 and the n speaker units 100 are connected to each other via a network 300. The network 300 is implemented by, for example, a wired or wireless LAN.

When a musical tone signal and a control signal are input to the input/output section 20 of the wireless LAN station 200, the musical tone signal and the control signal are converted into digital signals by the A/D converter 20a. The musical tone signal and control signal thus converted into digital form are output to the communicating section 40. Upon receiving the musical tone signal and the control signal, the communicating section 40 transmits the musical tone signal and the control signal to the wireless LAN station 400 by radio.

Upon receiving the musical tone signal and control signal, the communicating section 50 of the wireless LAN station 400 outputs the received musical tone signal and control signal to the signal processing section 30. As is the case with the first embodiment, the signal processing section 30 carries out processing on the musical tone signal, which is required for generating acoustic beams, and generates different pieces of musical tone data for the respective n speaker units 100. The signal processing section 30 transmits the different pieces of musical tone data associated with the respective n speaker units 100 to the respective speaker units 100 via the network 300.

Upon receiving the musical tone signal and the control signal, the AMP device 60 of the speaker unit 100 causes the D/A converter 60a to carry out digital-to-analog conversion of the output musical tone signal. The output musical tone signal thus converted into analog form is amplified by an amplifier 60b and output to the speaker 70. The speaker 70 outputs a musical tone based on the input musical tone signal. In this way, acoustic beams are selectively generated toward the positions designated by the control signal.

With the arrangement of the speaker array system 3 according to the present embodiment, since the AMP devices 60 and the speakers 70 correspond to each other on a one-on-one basis, the distance between the AMP device 60 and the speaker 70 can be minimized by configuring the AMP device 60 and the speaker 70 as an integral unit. As a result, sound quality can be improved. Further, with the arrangement of the speaker array system 3, since using the wireless LAN station 200 and the speaker units 100 eliminates the need to lay signal lines, wiring at the time of setup can be simplified, and the amount of work required for setup can be reduced. Also, since there is no need to lay signal lines, the problem that the probability of occurrence of connection errors is increased can be solved. Further, the cost of signal lines can be reduced, and the total weight of the speaker array system 3 can be decreased. In addition, since signal lines that cause so-called “fluttering sounds” are reduced, degradation of the quality of musical tones reproduced by the speaker array system 3 can be inhibited. Further, with the arrangement of the speaker array system 3, since only one communicating section 50 has to be provided for all the speakers 70, the arrangement of the speaker array system 3 can be simplified.

### Fourth Embodiment

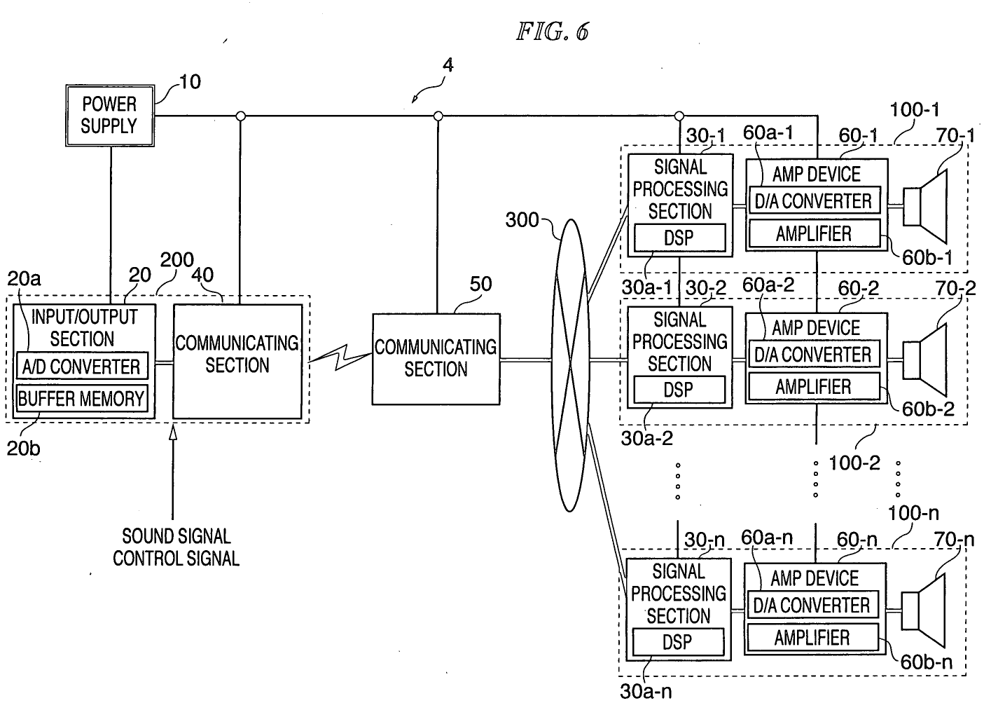

FIG. 6 is a block diagram showing the arrangement of a speaker array system 4 according to a fourth embodiment of the present invention. In FIG. 6, component elements corresponding to those of the speaker array systems 1, 2, and 3 according to the first to third embodiments are designated by identical reference numerals. Also, in the following description, differences from the first to third embodiments are focused, and description of matters in common with those of the first to third embodiments is omitted.

The speaker array system 4 differs from the speaker array system 3 according to the third embodiment in that each of speaker units 100 has the signal processing section 30. Specifically, as shown in FIG. 6, each of the speaker units 100 in the speaker array system 4 has the speaker 70, the AMP device 60, and the signal processing section 30. One communicating section 50 is shared by the n speaker units 100. The communicating section 50 and the n speaker units 100 are connected to each other via the network 300. The network 300 is implemented by, for example, a wired or wireless LAN.

When a musical tone signal and a control signal are input to the input/output section 20 of the wireless LAN station 200, the musical tone signal and the control signal are converted into digital signals by the A/D converter 20a. The musical tone signal and control signal thus converted into digital form are output to the communicating section 40. Upon receiving the musical tone signal and the control signal, the communicating section 40 transmits the musical tone signal and the control signal to the communicating section 50 by radio.

Upon receiving the musical tone signal and control signal, the communicating section 50 transmits the received musical tone signal and control signal to each of the speaker units 100 via the network 300. Upon receiving the musical tone signal and the control signal via the network 300, the signal processing section 30 of the speaker unit 100 carries out processing on the musical tone signal, which is required for generating acoustic beams, and generates an output musical tone signal for outputting a musical tone via the corresponding speaker 70 as is the case with the second embodiment. The signal processing section 30 outputs the generated musical tone data to the AMP device 60.

Upon receiving the musical tone signal and the control signal, the AMP device 60 causes the D/A converter 60a to carry out digital-to-analog conversion of the output musical tone signal. The output musical tone signal thus converted into analog form is amplified by an amplifier 60b and output to the speaker 70. The speaker 70 outputs a musical tone based on the input musical tone signal. In this way, acoustic beams are selectively generated toward the positions designated by the control signal.

With the arrangement of the speaker array system 4 according to the present embodiment, since the AMP devices 60 and the speakers 70 correspond to each other on a one-on-one basis, the distance between the AMP device 60 and the speaker 70 can be minimized by configuring the AMP device 60 and the speaker 70 as an integral unit. As a result, sound quality can be improved. Further, with the arrangement of the speaker array system 4, since using the wireless LAN station 200 and the speaker units 100 eliminates the need to lay signal lines, wiring at the time of setup can be simplified, and the amount of work required for setup can be reduced. Also, since there is no need to lay signal lines, the problem that the probability of occurrence of connection mistakes is increased can be solved. Further, the cost of signal lines can be reduced, and the total weight of the speaker array system 4 can be decreased. In addition, since signal lines that cause so-called “fluttering sounds” are reduced, degradation of the quality of musical tones reproduced by the speaker array system 4 can be inhibited. Further, with the arrangement of the speaker array system 4, since only one communicating section 50 has to be provided for all the speakers 70, the arrangement of the speaker array system 4 can be simplified.

### Other Embodiments

It should be understood that the present invention is not limited to the embodiments described above, but various changes in or to the above described embodiments may be possible without departing from the spirits of the present invention, including changes as described below.

Although in the above described embodiments, the present invention is applied to the speaker array system, the present invention may be applied to a microphone array system. In the case where the present invention is applied to a microphone array system, the flows of signals are reverse to those in the speaker array system described above.

Also, although in the above described embodiments, the wireless LAN technology is used for communication between the communicating section 40 and the communicating section(s) 50, any wireless communication technology other than the wireless LAN technology may be used. For example, electromagnetic waves used in wireless communication are limited to those having frequencies of 2.4 GHz, 5.2 GHz, etc., but electromagnetic waves having various frequencies such as infrared rays, visible light, and so forth may be used. In the case where infrared rays or visible light is used, the communicating section 40 has a light-emitting device such as a laser diode, and the communicating section 50 has a light-receiving device such as a photodiode. In this case, the communicating section 40 and the communicating section(s) 50 are arranged in opposed relation to make wireless communication possible.

Further, a variety of methods using time division, frequency division, code division, and space division may be used to transmit multichannel signals.

Further, although in the above described embodiments, the speaker units 100 are placed on the wall of the room R, this is not limitative, but the speaker units 100 may be mounted into a so-called speaker box cabinet (enclosure), not to a wall of a building. It should be noted that if speaker units are placed on a wall of a room as in the case of the above described embodiments, the entire room may be regarded as a speaker cabinet. It should be noted that the cabinet is made of a material capable of shielding electromagnetic waves, such as metal. If the cabinet is made of such a material that shields electromagnetic waves, electromagnetic waves from outside can be shielded, and electromagnetic waves from the speaker array system can be prevented from being leaked to outside. Alternatively, not the cabinet but the speaker units 100 themselves (the cases in which the speakers 70 are housed) may be made of a material that shields electromagnetic waves.

What is claimed is:

1. A speaker array system comprising:
a plurality of speakers mounted in a single speaker cabinet;
a plurality of amplifier devices that drive said plurality of speakers;
a signal processing device that carries out signal processing on an input musical tone signal so as to generate acoustic beams from outputs of said plurality of speakers; and
a wireless transmitting device and a wireless receiving device disposed on a signal path in a preceding stage or subsequent stage of said signal processing device, for transmitting and receiving signals by radio.

2. A speaker array system according to claim 1, wherein said signal processing device generates a plurality of output musical tone signals for respective ones of said plurality of speakers from the input musical tone signal,
said wireless transmitting device transmits by radio the plurality of output musical tone signals generated by said signal processing device,
said wireless receiving device comprises a plurality of wireless receivers provided in association with respective ones of said plurality of amplifier devices, for receiving associated ones of the plurality of output musical tone signals transmitted by radio and outputting the received output musical tone signals to respective associated ones of said plurality of amplifier devices, and
said plurality of amplifier devices, said signal processing device, said wireless transmitting device, and said plurality of wireless receivers are provided within the speaker cabinet.

3. A speaker array system according to claim 1, wherein said wireless transmitting device transmits the input musical tone signal by radio,
said wireless receiving device comprises a plurality of wireless receivers provided in association with respective ones of said plurality of amplifier devices, for receiving the input musical tone signal transmitted by radio,
said signal processing device comprises a plurality of signal processors provided in association with respective ones of said plurality of wireless receivers, for generating a plurality of output musical tone signals for respective ones of said plurality of speakers from the input musical tone signal received by said wireless receivers and outputting the generated output musical tone signals to respective associated ones of said plurality of amplifier devices, and
said plurality of amplifier devices, said plurality of signal processors, said wireless transmitting device, and said plurality of wireless receivers are provided within the speaker cabinet.

4. A speaker array system according to claim 1, wherein said wireless transmitting device transmits the input musical tone signal by radio,
said wireless receiving device receives the input musical tone signal transmitted by radio,
said signal processing device generates a plurality of output musical tone signals for respective ones of said plurality of speakers from the input musical tone signal received by said wireless receiving device and outputs the generated output musical tone signals to respective associated ones of said plurality of amplifier devices via a network, and
said plurality of amplifier devices, said signal processing device, said wireless transmitting device, and said wireless receiving device are provided within the speaker cabinet.

5. A speaker array system according to claim 1, wherein said wireless transmitting device transmits the input musical tone signal by radio,
said wireless receiving device receives the input musical tone signal transmitted by radio,
said signal processing device comprises a plurality of signal processors provided in association with respective ones of said plurality of amplifier devices and connected to said wireless receiving device via a network, for generating a plurality of output musical tone signals for respective ones of said plurality of speakers from the input musical tone signal received by said wireless receiving device and outputting the generated output musical tone signals to respective associated ones of said plurality of amplifier devices, and
said plurality of amplifier devices, said plurality of signal processors, said wireless transmitting device, and said wireless receiving device are provided within the speaker cabinet.

6. A speaker array system according to claim 1, wherein the speaker cabinet is formed of a material that shields electromagnetic waves.

7. A speaker array system according to claim 1, wherein each of said plurality of speakers comprises a case formed of a material that shields electromagnetic waves.

8. A speaker array system according to claim 1, wherein each of said plurality of speakers and each of said plurality of amplifier devices are housed in a speaker unit, and said speaker unit is comprised of a cylindrical exterior member on which screw threads for fitting said speaker unit into the speaker cabinet are formed and that is made of a conductive material, terminals that are made of a conductive material, and an insulating layer that is formed between the cylindrical exterior member and the terminals.
